(19) United States
(12) Patent Application Publication
(10) Pub. No.: US 2020/0212429 A1
(43) Pub. Date: Jul. 2, 2020

(54) Magnetic Templating in Electrode Manufacturing

(71) Applicant: SF Motors, Inc., Santa Clara, CA (US)

(72) Inventors: Willy Sandi Halim, Santa Clara, CA (US); Yu-Hsin Huang, Milpitas, CA (US); Chien-Po Huang, Campbell, CA (US); Ying Liu, Santa Clara, CA (US); Yifan Tang, Santa Clara, CA (US); Chengyu Mao, Santa Clara, CA (US)

(73) Assignees: Chongqing Jinkang New Energy Vehicle, Ltd., Chongqing (CN); SF Motors, Inc., Santa Clara, CA (US)

(21) Appl. No.: 16/237,513

(22) Filed: Dec. 31, 2018

(51) Int. Cl. H01M 4/139; H01M 4/04; H01M 10/0525; B05D 3/00

(52) U.S. Cl. CPC H01M 4/139; H01M 4/0404; H01M 2220/20; H01M 10/0525; B05D 3/207; H01M 4/0471

(57) ABSTRACT

External forces are applied to a slurry mixture to achieve a more organized slurry structure in the manufacturing of an electrode. A slurry is generated with paramagnetic materials that exhibit magnetic properties when a magnetic field is applied to the slurry. The slurry with the paramagnetic materials is applied to a current conductor, and then a magnetic field is applied to the slurry, for example during an electrode drying process. By applying a magnetic field, the paramagnetic material orientation can be aligned into a more organized structure. In some instances, the alignment creates a porous structure or gap between pillars that form within the dried slurry material. The dried, porous slurry structure allows for electrolyte wetting and ionic accessibility that is greatly improved over electrodes manufactured using typical techniques.

### BACKGROUND

Lithium ion batteries have become very popular for products and systems suited for rechargeable battery solutions. To manufacture a lithium battery, electrodes are constructed using a slurry coating applied to a current conductor material. Previous processes of applying a slurry coating and drying the slurry result in a disorganized and random structure on the anode and/or cathode current conductor materials. This disorganized and random morphology increases the tortuosity within the structure of the dried and inhibits electrolyte wetting on the system. To circumvent this problem, excess electrolyte material is added to a lithium ion cell to increase the gradient concentration and improve the driving force of the electrolytes within the cell. Though this serves to temporarily circumvent the problem of inhibited electrolyte wetting, excess electrolytes raise safety issues stemming from the toxicity of the electrolyte and adds to the cost of production due to extra electrolyte material required for the lithium ion cell. What is needed is an improved method for manufacturing lithium batteries.

### SUMMARY

The present technology, roughly described, uses external forces applied to a slurry mixture to achieve a more organized slurry structure. A slurry is generated with paramagnetic materials that exhibit magnetic properties when a magnetic field is applied to the slurry. The slurry with the paramagnetic materials is applied to a current conductor, and then a magnetic field is applied to the slurry, for example during an electrode drying process. By applying a magnetic field, the paramagnetic material orientation can be aligned into a more organized structure. In some instances, the alignment creates a porous structure or gap between pillars that form within the dried slurry material. The dried, porous slurry structure allows for electrolyte wetting and ionic accessibility that is greatly improved over electrodes manufactured using typical techniques.

Once the electrodes are generated, electrolytes may easily penetrate through gaps formed by the pillar structure. Lithium-ion intercalation also occurs faster because there are better pathways and more accessible reaction sites, at least because the organized structure leads to more intercalation. This provides for reduced diffusion limitation, and the reaction of the working battery can occur faster due to increased availability of reaction sites. As a result, less electrolytes can be utilized in the lithium battery, which reduces the cost of production and toxicity risks.

In embodiments, a system for manufacturing an electrode is disclosed. The system can include a coating machine, a slurry applicator, and a magnetic field source. The coating machine can secure a current conductor. The slurry applicator can apply a slurry to a first surface of the current conductor. The slurry can include an active material, conductive material, a binder, and paramagnetic material. The magnetic field source can be positioned above the slurry that applies a magnetic field to the slurry on the first surface of the current conductor. The magnetic field can affect the structure of portions of the slurry having the paramagnetic particles.

In embodiments, a method for manufacturing an electrode is disclosed. The method beings with applying a slurry to a surface of a current conductor. The slurry can include an active material, conductive material, a binder, and paramagnetic material. The slurry applied to the surface of the current conductor is dried, and a magnetic field is applied to the slurry during the drying process. The magnetic field can affect the structure of portions of the slurry having the paramagnetic particles.

In embodiments, an electrode of a rechargeable battery is disclosed. The electrode includes a current collector and a slurry coating. The slurry coating is on a first surface of the current conductor and includes active mass and paramagnetic particles. The slurry has a structure that is aligned anisotropically in response to a magnetic field applied to the slurry before the slurry has dried on the first surface of the current conductor.

### BRIEF DESCRIPTION OF FIGURES

FIG. 1 is a block diagram of a system for manufacturing an electrode.

FIG. 2 is a method for generating a lithium battery.

FIG. 3 is a method for constructing electrodes.

FIG. 4 is a method for performing an electrode drying process with a magnetic field.

FIG. 5A illustrates a table showing anode slurry components.

FIG. 5B illustrates a table showing cathode slurry components.

FIG. 6 illustrates a slurry with paramagnetic particles applied to a current conductor.

FIG. 7A illustrates a slurry with paramagnetic particles in a drying chamber.

FIG. 7B illustrates a magnetic field applied to a slurry having paramagnetic particles in a drying chamber.

FIG. 8 illustrates an electrode structure having random bead alignment.

FIG. 9 illustrates an electrode structure having anisotropic bead alignment.

FIG. 10 illustrates the orientation aligned perpendicular to a magnetic field.

### DETAILED DESCRIPTION

The present technology includes a method for manufacturing electrodes uses external forces applied to a slurry mixture to achieve a more organized slurry structure. A slurry is generated with paramagnetic materials that exhibit magnetic properties when a magnetic field is applied to the slurry. The slurry with the paramagnetic materials is applied to a current conductor, and a magnetic field is applied to the slurry, for example during an electrode drying process. By applying the magnetic field, the slurry material orientation can be aligned into a more organized structure. In some instances, the alignment creates a porous structure or gap between pillars that form within the dried slurry material. The dried, porous slurry structure allows for electrolyte wetting and ionic accessibility that is greatly improved over electrodes manufactured using traditional techniques.

Once the electrodes are generated, electrolytes may easily penetrate through gaps formed by the pillar structure, and lithium-ion intercalation occurs faster because there are better pathways. There are more reaction sites which are accessible in the organized structure, which leads to more intercalation. This provides for reduced diffusion limitation, and the reaction of the working battery can occur faster due to increased availability of reaction sites. As a result, less electrolytes can be utilized in the lithium battery, which reduces the cost of production and increases toxicity risks.

The current technology relates to a number of technical problems, including but not limited to the challenges of manufacturing safer, more efficient, and cheaper lithium ion batteries. Previous manufacturing techniques apply a slurry having an active material, conductive material, and a binder to a current conductor. The slurry is applied in the form of a thin film, and then is dried on the current conductor through a drying process. At a macroscopic level, the thin-film slurry appears to look uniform. At a microscopic level, however, the structure of the slurry can be seen to exhibit a disorganized structure. In particular, the slurry dries into particles or beads that are randomly oriented, resulting in a disorganized structure. This causes a problem during electrolyte wetting. In particular, when electrolytes are placed into a complex structure with less surface area, it requires more electrolytes to be introduced into the system. The additional electrolytes increase exposure and create safety issues. These electrolytes have a hard time penetrating into some areas of the slurry structure.

Electrodes of the prior art are constructed using a slurry coating. Previous processes of applying a slurry coating to an electrode result in a disorganized structure on the anode and/or cathode materials after a drying process is completed. This morphology increases the tortuosity and inhibits electrolyte wetting on the system. To circumvent this problem, excess electrolyte material is added to increase the gradient concentration and improve the driving force of the electrolyte. Though this serves to temporarily circumvent the problem, excess electrolytes raise safety concerns from the toxicity of the current electrolyte and adds to the cost of production based on the extra electrolyte material required. Hence, the prior art does not offer a desirable solution to the technical problem of manufacturing safer, more efficient, and cheaper lithium ion batteries.

The current technology provides a technical solution to the technical problem of manufacturing lithium-ion batteries. Specifically, the present technology provides an improved method for manufacturing a lithium-ion battery that involves including para magnetic particles within a slurry and manipulating the structure of the dried slurry by applying a magnetic field to the paramagnetic particles. The resulting structure is organized in that the orientation of the particles is aligned into pillar type shapes. The pillar shapes provide more gaps and surface area, which then requires less electrolytes to access more surface area of the slurry components. The benefits of the current method include a more organized structure, which has lower tortuosity that requires less electrolytes. With a smaller quantity of electrolytes, less wetting is required, and the cost of the battery is reduced. Additionally, the battery can handle a quick or fast charging process.

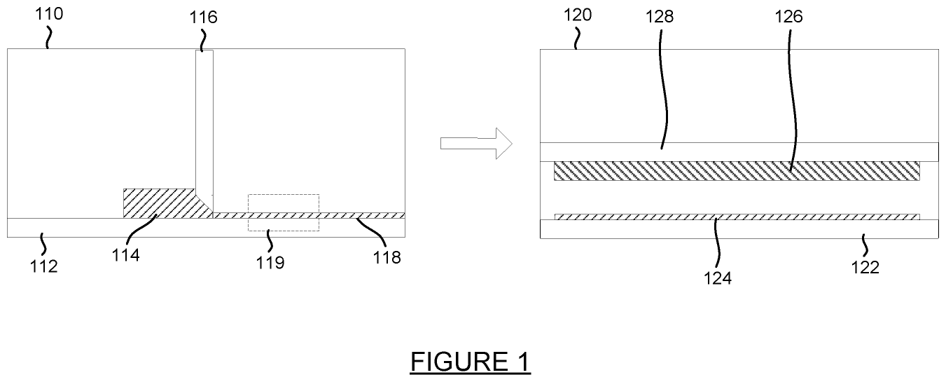

FIG. 1 is a block diagram of a system for manufacturing an electrode. The block diagram of FIG. 1 includes coating machine 110 and drying chamber 120. The system of FIG. 1 is exemplary and, for purposes of discussion, only illustrates selected portions of a typical electrode manufacturing system. Coating machine 110 includes current conductor 112, a reservoir of slurry 114, a blade 116, and slurry applied to the current conductor 118. The coating machine receives and/or supports the current conductor and secures the current conductor so that it can receive an application of slurry to a surface of the conductor. The current conductor may include a sheet or foil of material, such as copper or aluminum.

A reservoir of slurry 114 may be applied as a thin film to current conductor 112 using a slurry applicator device, such as for example blade 116. The blade 116 may be moved in a direction along the current conductor at a particular height to create a specific thin-film. The current conductor may be comprised of different materials, depending on the type of electrode and the application. In some instances, an anode current conductor can be made of copper while a cathode current conductor can be made of aluminum.

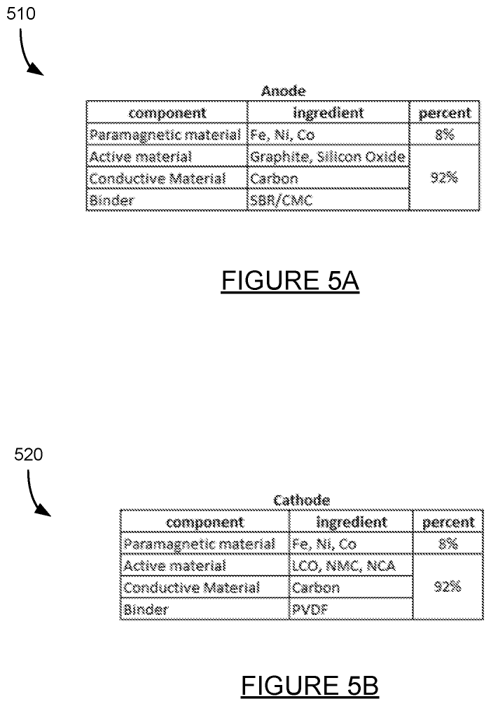

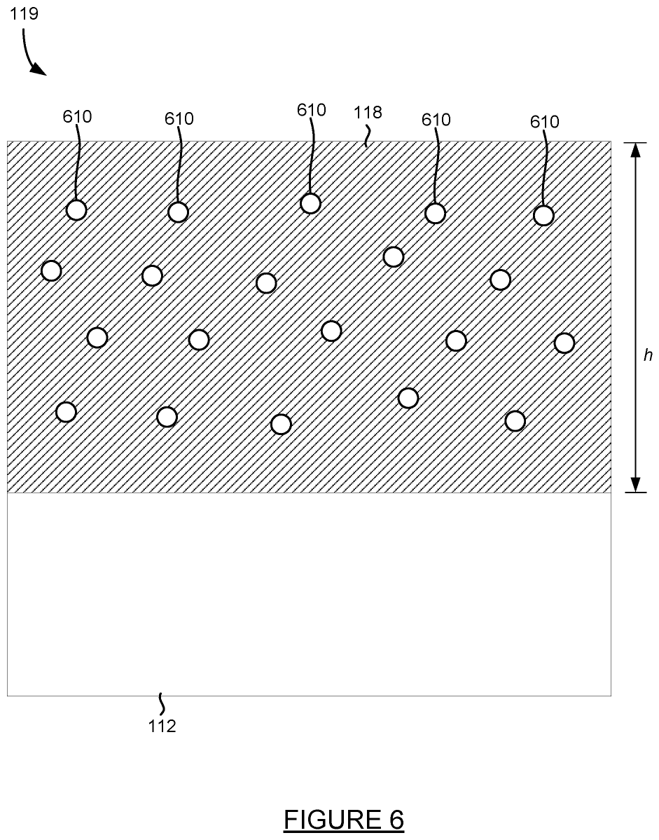

The slurry that is applied to the current conductor may include paramagnetic materials. Paramagnetic materials may include particles, such as for example nanoparticles, of a paramagnetic material, such as for example one or more of nickel (Ni), iron (Fe), and cobalt (Co). The nanoparticle paramagnetic materials may be such that they are well suited to be thoroughly mixed into the slurry. Contents of a slurry for an anode and cathode are discussed in more detail below with respect to FIGS. 5A-5B, respectively. More detail for a thin-film of slurry having magnetic material is discussed with respect to the FIG. 6.

Drying chamber 120 may receive a current conductor with a slurry thin film applied to a surface of the conductor. Once received, the drying chamber may dry the slurry. The slurry may be dried at a controlled temperature, such as for example room temperature or some other temperature.

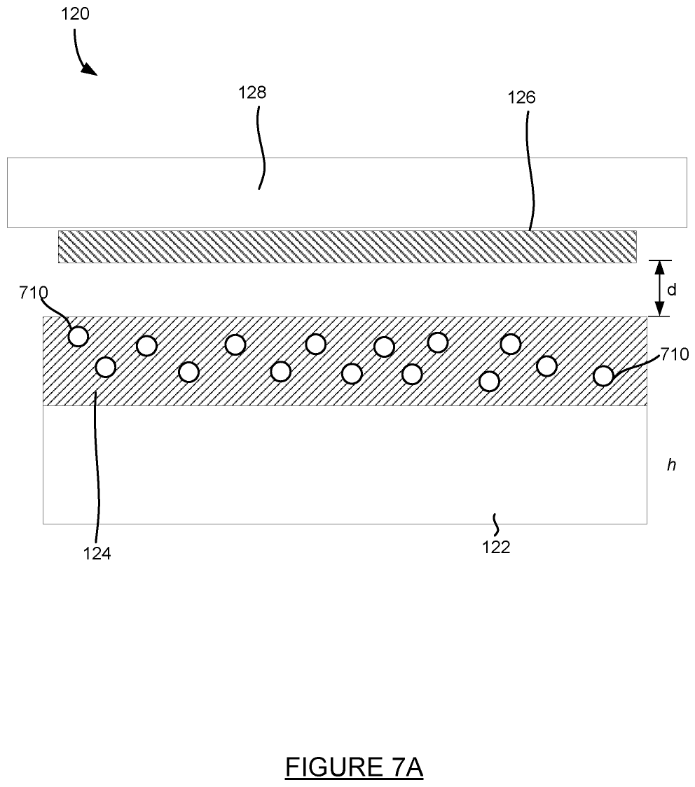

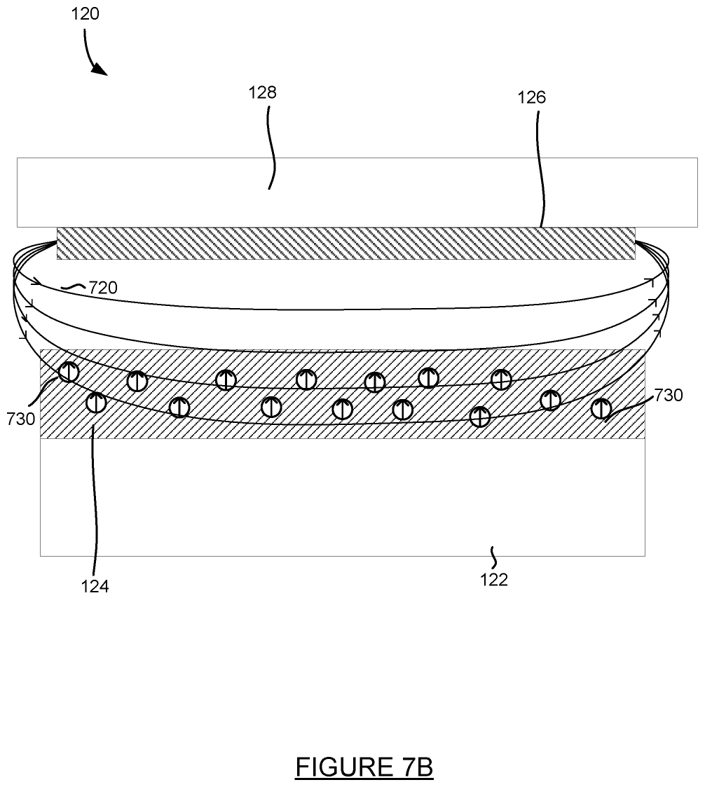

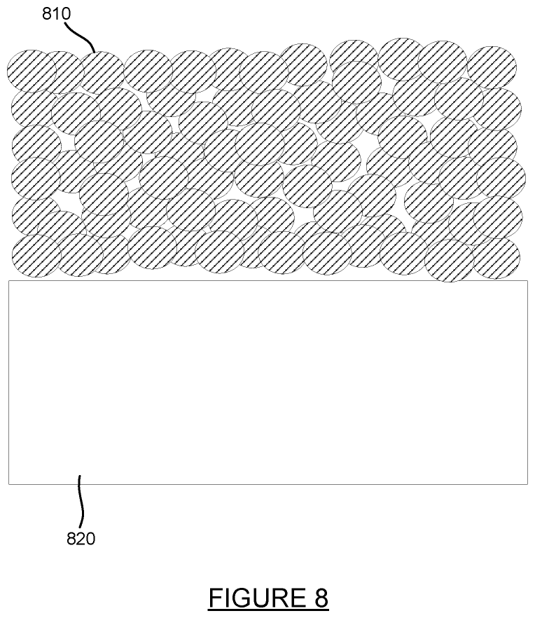

A magnetic field may be applied to the slurry within the drying chamber to create an orientation of organized and aligned slurry particles or beads. A magnetic field source 126 can be positioned, manipulated and secured within the drying chamber by a magnetic field source controller 128. The magnetic field source may include a magnet such as a neodymium magnet. The magnet may apply a magnetic field across the slurry as illustrated in FIG. 7B and discussed in more detail below. A controller may manipulate parameters for the magnet, such as the distance from the slurry thin film, an orientation of the magnet with respect to the thin film, the strength of the magnetic field and whether the magnetic field is on or off, and other parameters. More detail for a drying chamber 120 that applies a magnetic field to a slurry is discussed below with respect to FIG. 7A-B.

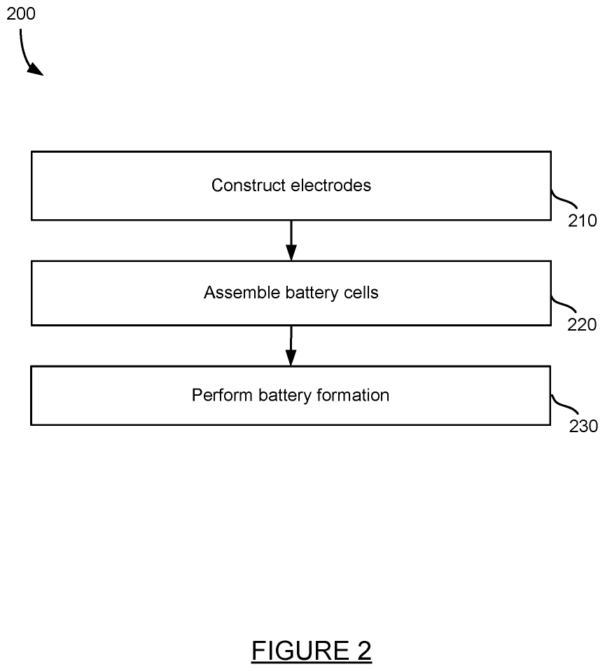

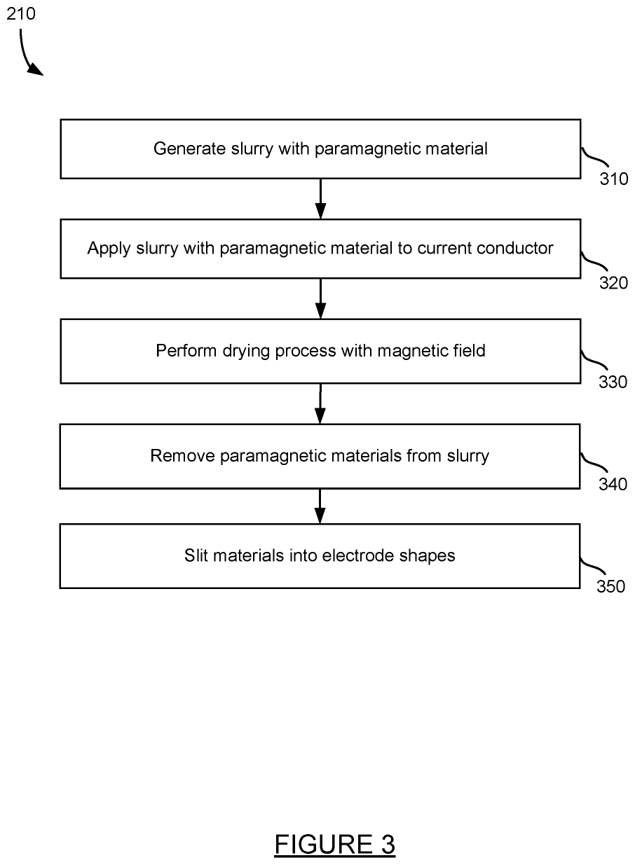

FIG. 2 illustrates a method for generating a lithium battery. The method for generating a lithium battery may be used for different types of rechargeable lithium batteries, such as those used in electronic vehicles, phones, and other devices. First, electrodes may be constructed at step 210. To generate an electrode, a slurry may be generated and applied to a current conductor, the slurry may be dried while being subjected to a magnetic field, and then the selected material may be slit into the appropriate size electrodes. More detail for generating electrode is discussed with respect to the method of FIG. 3.

Battery cells may be assembled at step 220. Assembling lithium-ion battery cells may include connecting electrodes, inserting electrode structures into a case, and then building the electrode subassembly. The subassembly is then injected into a can, and the can is sealed while leaving an opening for injecting electrolytes in the can. The cells can then be filled with electrolytes and sealed. Battery formation is then performed at step 230. The battery formation puts the cell through a precisely controlled charge and discharge cycle to activate the working materials of the battery and transform them into a usable form.

FIG. 3 illustrates a method for constructing electrodes. The method of FIG. 3 provides more detail for step 210 of the method of FIG. 2. A slurry with a paramagnetic material is generated at step 310. The slurry is generated as a mixture of a paramagnetic material, an active material, a conductive material, the binder. These materials are mixed in a planetary vacuum mixer, sometimes with water and/or other materials, for a period of time required to achieve a complete and even mixture. In some instances, the ingredients are placed in a planetary vacuum mixer for between 30 and 40 minutes.

A slurry for an anode can be made from a variety of materials. FIG. 5A illustrates a table showing an exemplary percentage makeup of some suitable anode components. For anode of a lithium-ion battery of the present technology, the active material, conductive material, and binder may form 92% of the slurry while the paramagnetic material makes up 8% of the slurry. The paramagnetic material may include iron, nickel, or cobalt, or some other suitable paramagnetic material. The active material for an anode may include graphite, silicon oxide, or some other suitable active material for an anode. The conductive material may include carbon or some other suitable conductive material, while the binder may include styrene butadiene rubber (SBR), carboxymehtyl cellulose (CMC), or some other suitable binder. In some instances, the percentage makeup of the paramagnetic material and other materials in an anode may differ from percentages illustrated in FIG. 5A, based on the application of the battery and the structure desired in the dried slurry.

A slurry for a cathode can also be made from a variety of materials. FIG. 5B illustrates a table showing percentage makeup of a cathode component. For a cathode of a lithium-ion battery of the present technology, the active material may include lithium cobalt oxide, lithium nickel magnesium cobalt oxide, lithium nickel cobalt aluminum oxide, or some other suitable active material for a cathode. The conductive material may be carbon or some other suitable conductive material, while a binder may be implemented as polyvinylidene fluoride (PVDF) or in other suitable binder. The paramagnetic material may include iron, nickel, cobalt, or some other suitable paramagnetic material, and may make up about eight percent of a slurry used to create a cathode. The active material, conductive material, and binder may make up about 90% of the slurry used to create a cathode. In some instances, the percentage makeup of the paramagnetic material and other materials in a cathode may differ from percentages illustrated in FIG. 5A, based on the application of the battery and the structure desired in the dried slurry

Returning to the method of FIG. 3, a slurry with a paramagnetic material is applied to a current conductor at step 320. The curry may be applied in a manner that leaves a thin-film on the current conductor surface. For example, a doctor blade or other suitable application mechanism may apply the slurry at a height that is suitable for the particular application. In some instances, the doctor blade may be used to apply the slurry to a current conductor at a height of 65 μm.

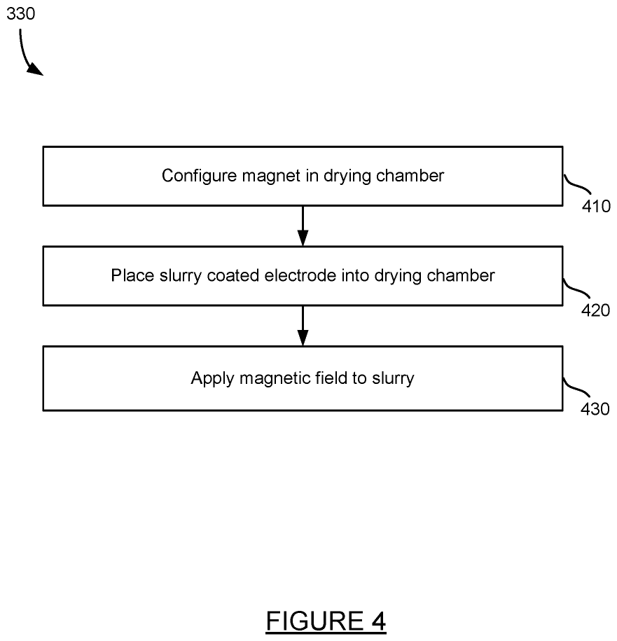

A drying process is performed while applying a magnetic field to a slurry at step 330. During the drying process, the magnetic field is applied, such as for example by a neodymium magnet, to achieve isotropic alignment of slurry particles or beads. Performing a drying process with a magnetic field is discussed in more detail below with respect to the method of FIG. 4.

Paramagnetic materials may be removed from a slurry at step 340. In some instances, the paramagnetic materials may be removed, for example towards the end of or after the drying process, to retain the alignment of the slurry material. The paramagnetic materials may be removed by a chemical process or some other process. Electrode materials may then be slit into electrode shapes at step 350. Electrode shapes may be selected based on the application and size of the batteries in which the electrodes will be used.

FIG. 4 is a method for performing a drying process with a magnetic field. The method of FIG. 4 provides more detail of step 330 of the method of FIG. 3. A magnet can be configured within a drying chamber at step 410. The magnet, such as a neodymium magnet may be configured by positioning the magnet based on an application and desired slurry structure. In some instances, a magnet is configured to apply a magnetic field of at least 140 milli-teslas to a slurry film applied to a surface of a current conductor. In some instances, a neodymium magnet may be placed about 1 cm from the surface of a slurry thin-film. A magnet may be further configured by setting the strength of magnetic field provided by the magnet as well as an orientation of the magnet towards the slurry surface. In some instances, a magnet may be applied parallel to or at some angle with respect to a slurry surface in order to configure the direction of slurry particle orientation for different applications.

A slurry coded electrode is placed into a drying chamber at step 420. Once inside the drying chamber, the slurry can be dried while a magnetic field is applied to the slurry at step 430. The magnetic field may be applied with a consistent location and magnetic field strength. In some instances, the magnetic field can be applied periodically or intermittently, as well as from a varying location during the drying process. In some instances, more than one magnet can be used to apply the magnetic field to the slurry.

FIG. 6 illustrates a slurry with paramagnetic particles applied to a current conductor. The slurry and current conductor of FIG. 6 provides more detail for the slurry and conductor cross-section portion 119 of FIG. 1. Slurry 118 is a mixture of paramagnetic material 610, active material, conductive material and binder. The height h of the slurry on the current conductor may be about 65 μm, corresponding to the height of a doctor blade used to create the thin film. The paramagnetic particles 610 may include nanoparticles dispersed throughout the slurry. In some instances, because they are paramagnetic, the slurry particles 610 do not exhibit magnetic properties until they experience a magnetic field applied to them from a magnet or other magnetic field source.

FIG. 7A illustrates a slurry with paramagnetic particles in a drying chamber. The drying chamber 120 of FIG. 7 a includes a current conductor 122 and slurry 124, a magnetic field controller 128, and a magnetic field source 126. The distance d between the lower surface of the magnetic field source, such as a magnet, and the upper surface of the slurry film 124, may be about 1 cm. In some instances, the distance may be greater or less than 1 cm, depending on the strength and direction of the magnetic field desired. The magnetic field strength may be about 140 milli-teslas or more.

FIG. 7B illustrates a magnetic field applied to a slurry having paramagnetic particles in a drying chamber. FIG. 7B illustrates the drying chamber 120 when the magnetic field source applies a magnetic field 722 to the slurry. In FIG. 7A, with no magnetic field, the particles do not have any organized orientation. When a magnetic field 720 is applied to the slurry as illustrated in FIG. 7B, the paramagnetic particles within the slurry exhibit properties which cause them to align in an organized structure. The orientation of the particles is perpendicular to the direction of the magnetic field, as illustrated in FIG. 7B.

FIG. 8 illustrates an electrode structure having random bead alignment. The slurry beads 810 materialize on a microscopic scale in the slurry after the slurry has dried. The random structure and orientation of beads 810 results when there is no external force applied to the slurry during drying. As a result, the slurry beats have random alignment—on a microscopic scale—after a typical dry process of the prior art is used. The structure does not have much spacing between the beads, which requires larger quantities of electrolytes during the wetting process for the cell, in turn resulting in a more expensive cell.

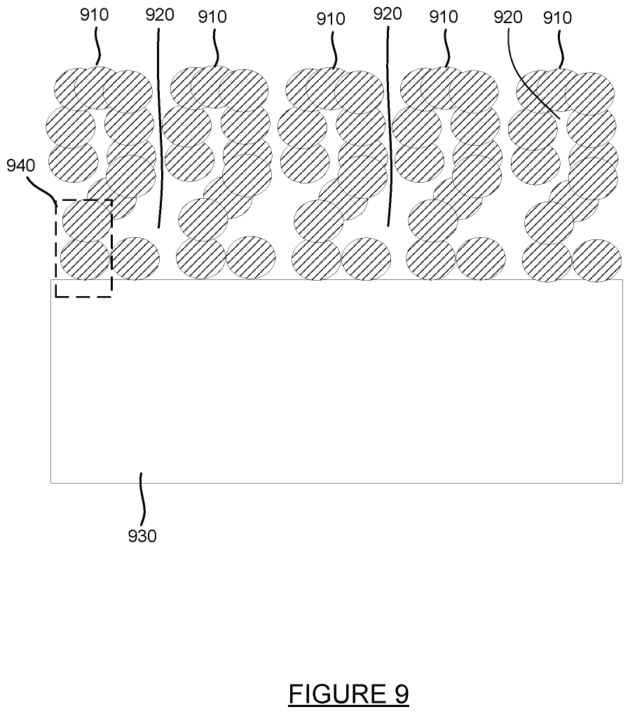

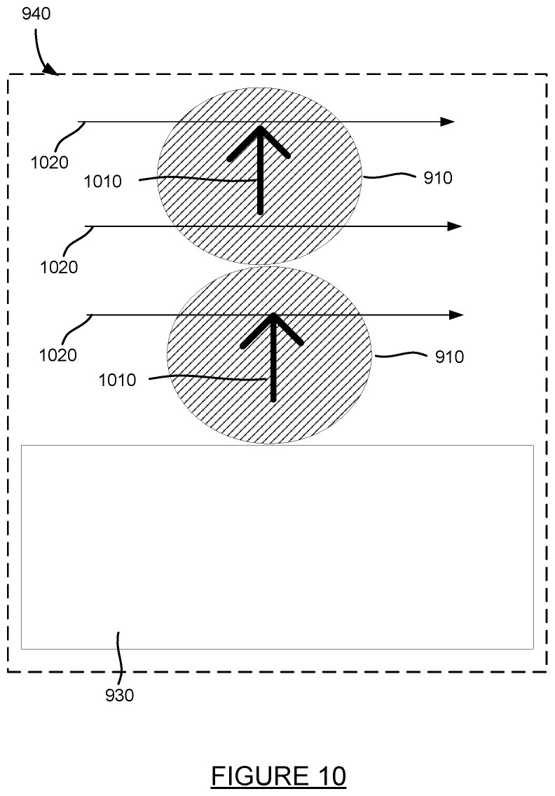

FIG. 9 illustrates an electrode structure having anisotropic beat alignment. Unlike the structure of the slurry beads of FIG. 8, the structure of the beads in FIG. 9 are shaped by the magnetic field as applied to the paramagnetic particles within the slurry. The structure includes gaps 920 between portions of the slurry structure. As a result of the magnetic field applied to the paramagnetic particles, the particles behave anistropically to form a structure comprised of a plurality of pillar-type shapes. As shown in FIG. 10, the pillars are formed from a plurality of beads, wherein the beads are aligned perpendicular to an applied magnetic field 1010. The pillar structure reduces the tortuosity present in the resulting electrode, which makes it easier for electrolytes to travel through the slurry structure space. This is contrary to prior methods, which result in an unorganized structure that require more electrolytes to wet the entire surface.

The structure that results from applying a magnetic field to paramagnetic particles within a slurry results in an organized structure with a lower tortuosity. The lower tortuosity results in less electrolytes being needed and less wetting. The smaller quantity of electrolytes provides for a lower cost lithium-ion battery cell, which can handle more fast charging then the VMI on batteries of the prior art.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A system for manufacturing an electrode, comprising:
a coating machine that secures a current conductor;
a slurry applicator to apply a slurry to a first surface of the current conductor, the slurry including an active material, conductive material, a binder, and paramagnetic material; and
a magnetic field source positioned above the slurry that applies a magnetic field to the slurry on the first surface of the current conductor, the magnetic field affecting the structure of portions of the slurry having the paramagnetic particles.

2. The system of claim 1, wherein the paramagnetic material includes particles of at least one of iron, nickel and cobalt.

3. The system of claim 1, wherein the particles include nanoparticles.

4. The system of claim 1, wherein the paramagnetic material is comprised of 8% slurry material.

5. The system of claim 1, wherein the magnetic field source is positioned to apply a magnetic field of at least 140 milli-tesla to the slurry.

6. The system of claim 1, wherein the magnetic field source is a neodymium magnet.

7. The system of claim 1, wherein the magnetic field is applied while drying the slurry onto the current conductor.

8. The system of claim 7, wherein the slurry dries into a plurality of beads, the beads aligned anisotropically at least in part because of the magnetic field applied to the slurry while drying the slurry.

9. A method for manufacturing an electrode, comprising:
applying a slurry to a surface of a current conductor, the slurry including an active material, conductive material, a binder, and paramagnetic material;
drying the slurry applied to the surface of the current conductor; and
applying a magnetic field to the slurry during the drying process, the magnetic field affecting the structure of portions of the slurry having the paramagnetic particles.

10. The method of claim 9, wherein the paramagnetic material includes particles of at least one of iron, nickel and cobalt.

11. The method of claim 9, wherein the particles include nanoparticles.

12. The method of claim 9, wherein the paramagnetic material comprises 8% of the slurry.

13. The method of claim 9, wherein applying the magnetic field includes applying a magnetic field of at least 140 milli-tesla to the slurry.

14. The method of claim 9, wherein the magnetic field source is applied by a neodymium magnet.

15. The method of claim 9, wherein the magnetic field is applied constantly to the slurry.

16. The method of claim 9, wherein the magnetic field varies in intensity.

17. The system of claim 7, wherein the slurry dries into a plurality of beads, the beads aligned anisotropically at least in part because of the magnetic field applied to the slurry while drying the slurry.

18. An electrode of a rechargeable battery, comprising:
A current conductor;
A slurry coating on a first surface of the current conductor, the slurry coating including an active mass and paramagnetic particles,
the slurry having a structure that is aligned anisotropically in response to a magnetic field applied to the slurry before the slurry has dried on the first surface of the current conductor.

19. The electrode of claim 18, wherein the slurry structure is formed by a plurality of beads, the beads structured in an anisotropic alignment.

20. The electrode of claim 18, wherein the electrode is used in a rechargeable battery for an electronic vehicle.
